(19) United States
(12) Patent Application Publication
(10) Pub. No.: US 2015/0047167 A1
(43) Pub. Date: Feb. 19, 2015

(54) Universal method of repairing damaged automotive composite headlight, fog light and taillight mounting assemblies

(71) Applicant: Luis Antonio Gonzalez, III, Adamstown, PA (US)

(72) Inventor: Luis Antonio Gonzalez, III, Adamstown, PA (US)

(21) Appl. No.: 13/969,572

(22) Filed: Aug. 18, 2013

(51) Int. Cl. B60Q 1/00; B60Q 1/04

(52) U.S. Cl. CPC B60Q 1/0064; B60Q 1/0433; B60Q 2900/20
USPC 29/402.08

(57) ABSTRACT

The damaged headlight, fog light or tail light mounting tab is repaired by cutting away all of the old damaged mount tab. The new mounting tab is bent and trimmed to mirror the old mount tab, then is screwed or glued down to the housing in replace of the old damaged mounting tab.

### BACK GROUND OF INVENTION

Automotive body repair often involves replacing damaged body parts with new parts rather than repairing the damaged part. Often because there are not repair parts available to repair the specific part in application. Even though repairing the damage part is far less costly then replacing it. If the repaired part is in an area that is not visible it will not be a problem from an appearance point of view.

Damaged automotive headlights, fog lights and tail light mounting tabs are excellent examples of a need for a universal style repair parts. So the headlights, fog lights and tail lights can be repaired for a fraction of the cost of the new part.

### DESCRIPTION

The method of this invention is that of replacing damaged automotive headlight, fog light and tail light mounting tabs with new universal mounting tabs. The universal mount tabs come in commonly need angles and lengths FIG. 9-FIG. 13 to make the custom bending and trimming of thee mounts easy even for the novice. The method involves bending and trimming the new universal mounting tab to the exact shape of the damaged mount tab. Once the desired shape of tab is made the method involves cutting away the old damaged mounting tab and replacing it with the new mount tab. The new mount tab may ether be screwed down FIG. 3 and FIG. 7 to the lamp housing or glued down FIG. 4 and FIG. 8 to the lamp housing. Drawing 1 and drawing 2 represent some but not all of the common applications of these universal mount tabs. Do the universal nature of these mounting tabs it is imposable to include all applications. The replacement mounting tabs can be bent and trimmed into an endless number of mounting tab configurations.

### DESCRIPTION OF DRAWINGS

FIG. 1 is a front view of a common style automotive headlight undamaged and an undamaged mounting tab.

FIG. 2 is an enlarged view of the upper mounting tab damaged. The doted line represents the damaged missing areas.

FIG. 3 is a view of the universal mounting tab after it has been bent and trimmed to the exact shape of the old damaged mount tab and is screwed down to the housing.

FIG. 4 is a view of the universal mounting tab after it has been bent and trimmed to the exact shape of the old damaged mount tab and is glued down to the housing.

FIG. 5 is a rear view of a common style automotive headlight undamaged and an undamaged mounting tab.

FIG. 6 is an enlarged view of the lower mounting tab damaged. The dotted line represents the damaged missing areas.

FIG. 7 is a view of the universal mounting tab after it has been bent and trimmed to the exact shape of the old damaged mount tab and is screwed down to the housing.

FIG. 8 is a view of the universal mounting tab after it has been bent and trimmed to the exact shape of the old damaged mount tab and is glued down to the housing.

FIG. 9 is a view of the new universal mounting tabs that come pre bent is common angles so that they can be easily further bent, if necessary, and trimmed to the exact shape of the old mounting tab. This view is of the 45 degree angle pre bent replacement tab.

FIG. 10 is a view of the new universal mounting tabs that come pre bent is common angles so that they can be easily further bent, if necessary, and trimmed to the exact shape of the old mounting tab. This view is of the 90 degree angle pre bent replacement tab.

FIG. 11 is a view of the new universal mounting tabs that come pre bent is common angles so that they can be easily further bent, if necessary, and trimmed to the exact shape of the old mounting tab. This view is of the flat wide replacement tab.

FIG. 12 is a view of the new universal mounting tabs that come pre bent is common angles so that they can be easily further bent, if necessary, and trimmed to the exact shape of the old mounting tab. This view is of the 45 degree bent by 45 degree angle pre bent replacement tab.

FIG. 13 is a view of the new universal mounting tabs that come pre bent is common angles so that they can be easily further bent, if necessary, and trimmed to the exact shape of the old mounting tab. This view is of the long flat replacement tab.

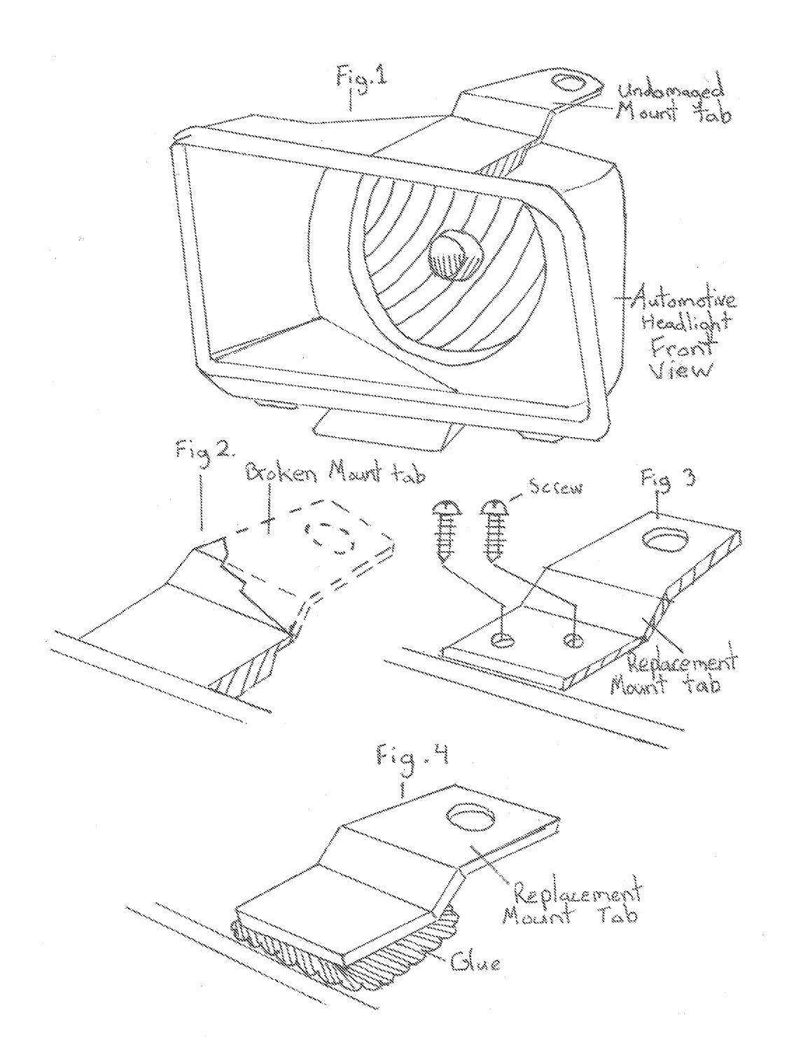

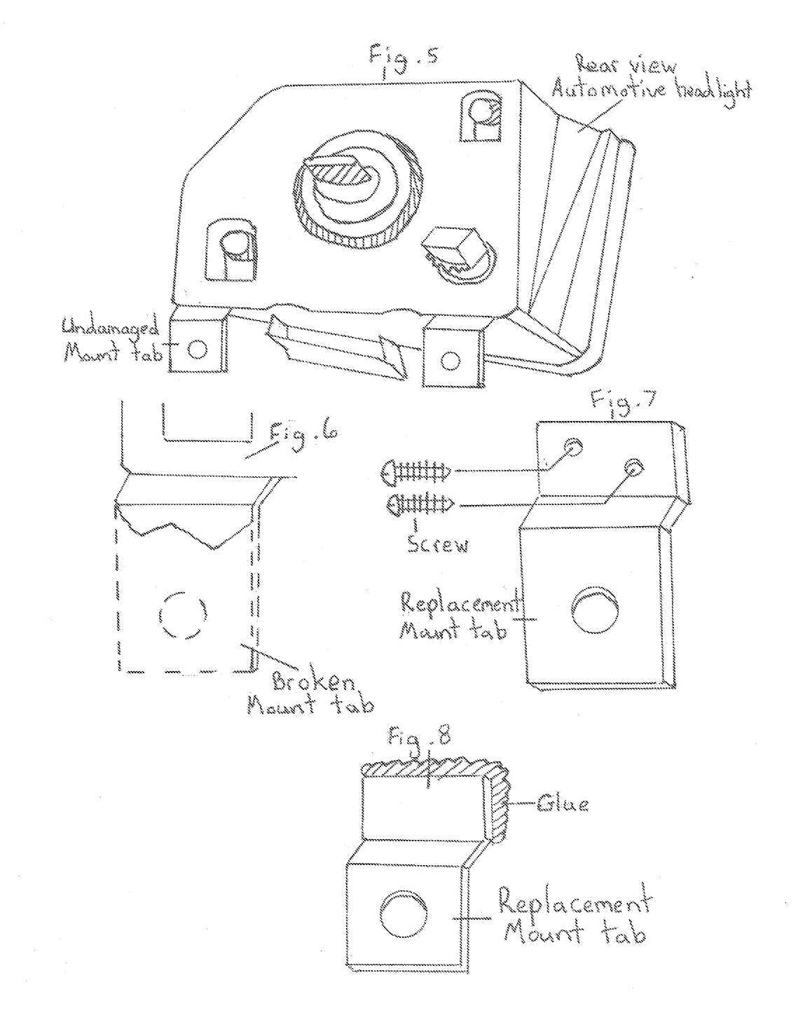

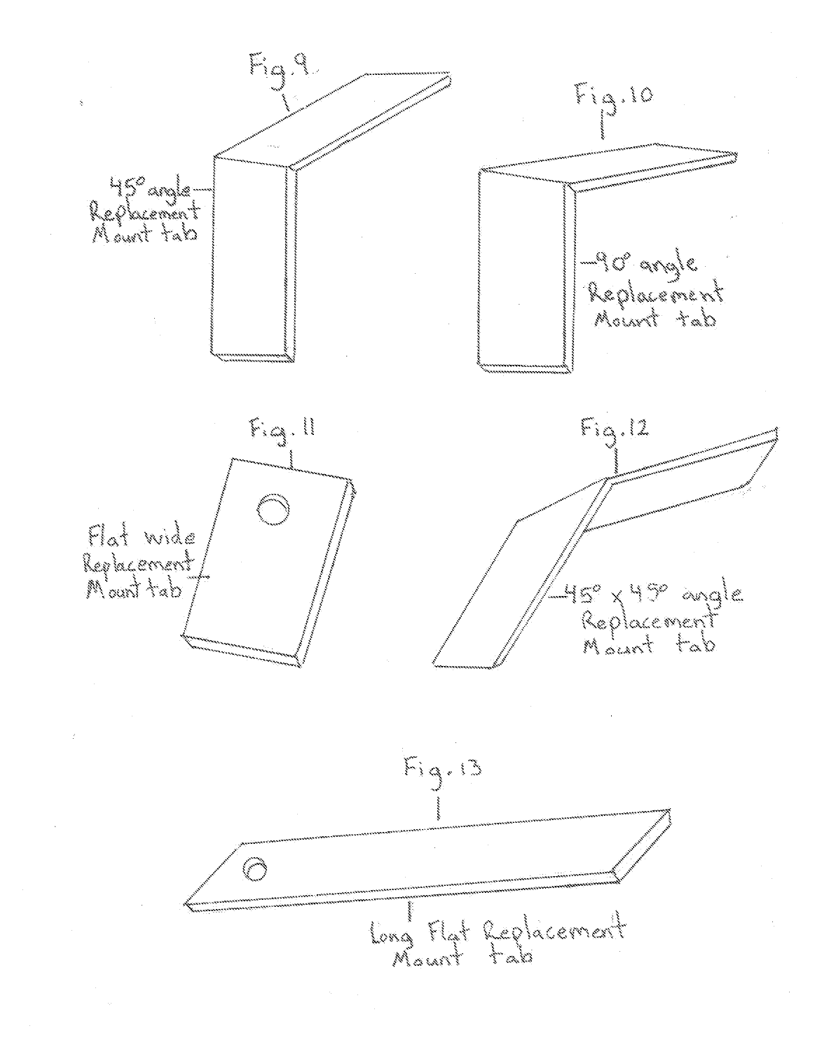

### SUMMARY

The method of this invention involves cutting away, if necessary, portions of the remaining damaged mounting tab on the lens assembly in such a way that the new tab maybe screwed, bolted or glued on as a replacement tab. The universal aspect of this invention is that the replacement mount tab bay be bent and trimmed to conform to an endless number of mounting tab conformations.

1. The universal method of replacing damaged automotive headlight, fog light and tail light mounting tabs with new universal mounting tabs.
a. Make the replacement tab by means of bending and trimming to mirror the exact shape of the old mounting tab to be replaced.
b. The damaged mounting tab is then cut off.
c. The replacement tab is then screwed or glued to the housing in replace of the old mounting tab.
d. The unique feature of this invention is the universal nature of the replacement mounting tabs. The replacement mounting tabs can be bent and trimmed into an endless number of mounting tabs configurations.
